(19) United States
(12) Patent Application Publication
(10) Pub. No.: US 2009/0078447 A1
(43) Pub. Date: Mar. 26, 2009

(54) CABLE, CONFIGURATION WITH THE CABLE, METHOD OF PRODUCING THE CABLE, AND APPARATUS FOR PRODUCING THE CABLE

(75) Inventors: Helmut Brantsch, Ingolstadt (DE); Martin Schramme, Regensburg (DE)

Correspondence Address: LERNER GREENBERG STEMER LLP, P O BOX 2480, HOLLYWOOD, FL, 33022-2480, US

(73) Assignee: CONTINENTAL AUTOMOTIVE GMBH, Hannover (DE)

(21) Appl. No.: 12/236,541

(22) Filed: Sep. 24, 2008

(30) Foreign Application Priority Data
Sep. 24, 2007 (DE) DE 102007045512.9

(51) Int. Cl. H01B 5/08; H01R 43/00

(52) U.S. Cl. 174/128.1; 29/868; 29/854

(57) ABSTRACT

A cable (30) has a stranded wire (4) made from a plurality of individual conductors (5), and at least one connection area (6). In the connection area (6), the stranded wire (4) is fused to form a compacted block, the compacted block having at least one through opening (9).

The invention relates to a cable, for example an earth cable for a car battery. Furthermore, it relates to an arrangement with the cable and a method and a device for manufacturing the cable.

If a cable is to be releasably electrically connected to an object, then a cable lug is used into which the cable is fed and clamped, and which has a through opening, for example, for accepting a screw or some other fixing facility. An example of such a cable lug is disclosed in DE 297 07 491 U1.

The disadvantage with such an arrangement is that the use of a cable lug is relatively laborious and therefore cost-intensive.

The object of the invention is therefore to specify a way in which a releasable electrical connection between a cable and another object can be created as simply as possible.

According to the invention, this object is achieved with the subject matter of the independent patent claims. Advantageous developments of the invention are the subject matter of the dependent claims.

A cable according to the invention has a stranded wire made from a plurality of individual conductors. The cable has at least one connection area in which the stranded wire is fused to form a compacted block, the compacted block having at least one central through opening.

With the cable according to the invention, the connection area with the through opening for fixing the cable is therefore designed to be integral with the cable. This is particularly advantageous in the case of earth cables for a car battery which incorporate an integral battery sensor. One end of such cables is connected to a shunt, which for its part is connected to a battery pole via a pole terminal. The other end of the cable is intended to be connected to the car body.

The connection between the one end of the cable and the shunt is made by fusing the individual conductors of the stranded wire by heating under pressure to form a compacted rectangular block, which is soldered to the shunt.

According to a basic principle of the invention, the compacting of the cable can also be used for providing a connection area at the other end of the cable. In order to make the connection releasable, this connection area has a through opening through which, for example, a screw or other fixing means can be fed.

This cable has the advantage that the connection to the car body is very stable and reliable over a long period due to the integral design of the connection area with the cable. Furthermore, it has the advantage that it can be manufactured very easily and cost-effectively, as both ends of the cable can be compacted using the same technology. The use of a separate cable lug is no longer necessary.

In an embodiment of the invention, at least a first end of the cable incorporates the connection area. The connection areas according to the invention can however also be provided on a second end of the cable or at any position between the ends of the cable.

In an embodiment, the central through opening has a round form. A round through opening is particularly advantageous when standard fixing means such as screws are to be used with the cable. However, the through opening can also have a special, non-round form.

In an embodiment, the cable has a first connection area at its first end and a second connection area at its second end in which the stranded wire is fused to form a compacted block, wherein only the compacted block at its first end has the central through opening. In this case, the cable can be releasably fixed by means of its first end, while its second end can be connected to an object by brazing or welding for example.

Alternatively, the cable has a first connection area at its first end and a second connection area at its second end in which the stranded wire is fused to form a compacted block, wherein each compacted block has a through opening so that a releasable connection of both ends is possible using a fixing means such as a screw.

Advantageously, the stranded wire is enclosed by an electrically insulating cable sheath. On the other hand, the compacted cable is advantageously bare in the connection area, enabling electrical contact to be made with it.

In an arrangement according to the invention with such a cable, the connection area of the cable is connected to an earth.

Advantageously, in doing so, the connection area of the cable connected to the earth by a screw connection, wherein a screw is fed through the through opening. Such a connection is stable and reliable, but at the same time can be released particularly easily.

In an embodiment, the cable is designed as an earth cable for a car battery, and the connection area of the cable is connected to the car body. The other end of the cable can be connected to a shunt, if the earth cable incorporates a battery sensor for example.

A method according to the invention for manufacturing a cable that has at least one connection area includes the following steps: a cable with a stranded wire comprising a plurality of individual conductors is provided. A pin is inserted between the individual conductors of the stranded wire in the connection area. An electrical current is applied to the stranded wire in the connection area and the stranded wire is heated in the connection area thus fusing the individual wires to form a compacted block with at least one through opening.

When the pin is inserted between the individual conductors of the stranded wire, the pin can divide the plurality of individual conductors into at least two strands at the position of a through opening. However, the pin can also be inserted in such a way that the stranded wire is not divided, but laid around the pin, thus producing a completely or partially closed eye.

In an advantageous embodiment, the individual wires are fused to form a compacted block with at least one through opening in a forming tool which has a cavity with a broadened area for accommodating the connection area of the cable. The stranded wire is placed in this forming tool for fusing, the forming tool being shaped and dimensioned in such a way that the individual conductors are pressed against the walls of the broadened area when the pin is inserted into the connection area.

Advantageously, a first electrode, which incorporates the pin, and a second electrode, which has a receptacle for the pin, are then used in order to apply an electrical current to the stranded wire. In doing so, the first electrode and the second electrode are inserted in the forming tool from opposite sides. In this way, the individual conductors can be plastically deformed using pressure and heat and fused into a block.

According to an aspect of the invention, a device for compacting a connection area of a cable that has a stranded wire comprising a plurality of individual conductors comprises a forming tool, which has a cavity for accommodating the stranded wire with a broadened area for accommodating the connection area of the cable. Furthermore, the device has a first electrode, which has a first contact area and at least one pin for inserting between the individual conductors of the stranded wire, and a second electrode, which has a second contacting area and a receptacle for the pin. Here, the contacting areas are each intended to make electrical contact with the stranded wire during the fusing process.

Advantageously, the electrical conductivity of the forming tool is at least two orders of magnitude less than that of the electrodes. Advantageously, the electrical conductivity of the pin is also at least two orders of magnitude less than that of the electrodes. This ensures that, during the fusing process, the main current flow takes place between the electrodes in the area of the individual wires to be fused.

For this purpose, the forming tool can be made essentially from a suitable ceramic. In an embodiment, the pin is also made essentially from ceramic. In this context, “made essentially from ceramic” means that the material properties of the forming tool and the pin, in particular the electrical conductivity, are predominantly determined by the ceramic components.

Exemplary embodiments of the invention are explained in more detail below with reference to the attached figures.

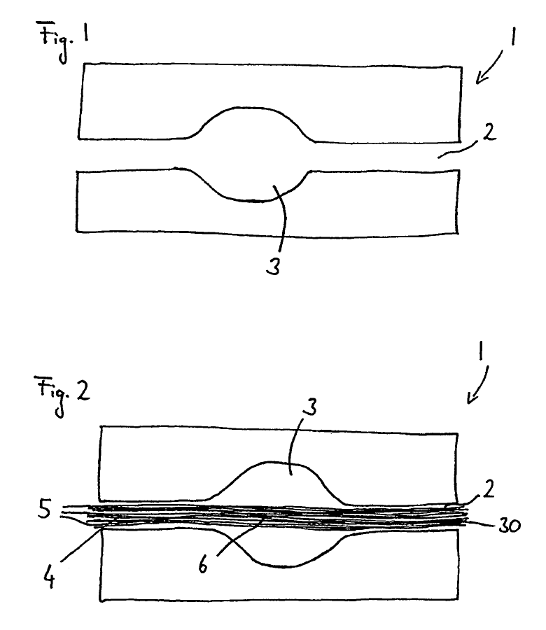

FIG. 1 shows schematically a plan view on a forming tool of a device according to an embodiment of the invention;

FIG. 2 shows schematically a step of a method according to an embodiment of the invention;

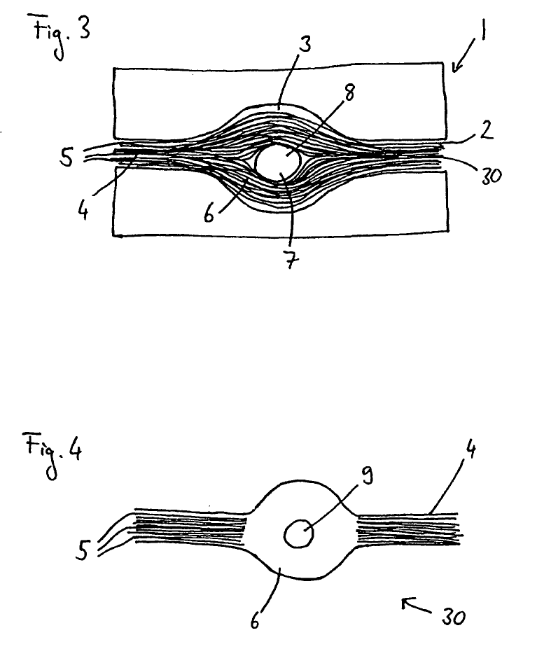

FIG. 3 shows schematically a further step of a method according to an embodiment of the invention;

FIG. 4 shows schematically a cable according to an embodiment of the invention;

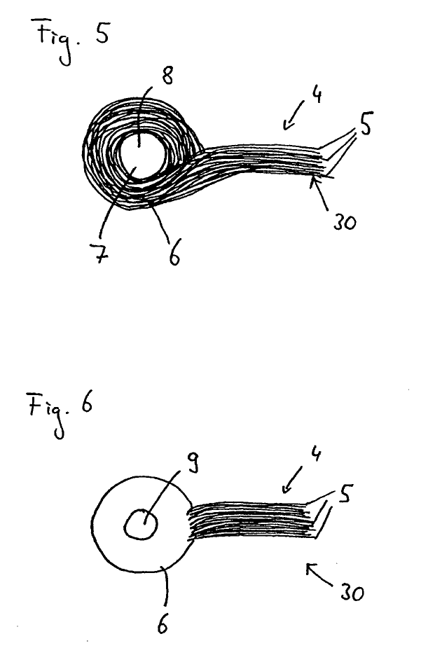

FIG. 5 shows schematically the method step shown in FIG. 3 in an alternative embodiment of the invention;

FIG. 6 shows schematically a cable according to the alternative embodiment of the invention;

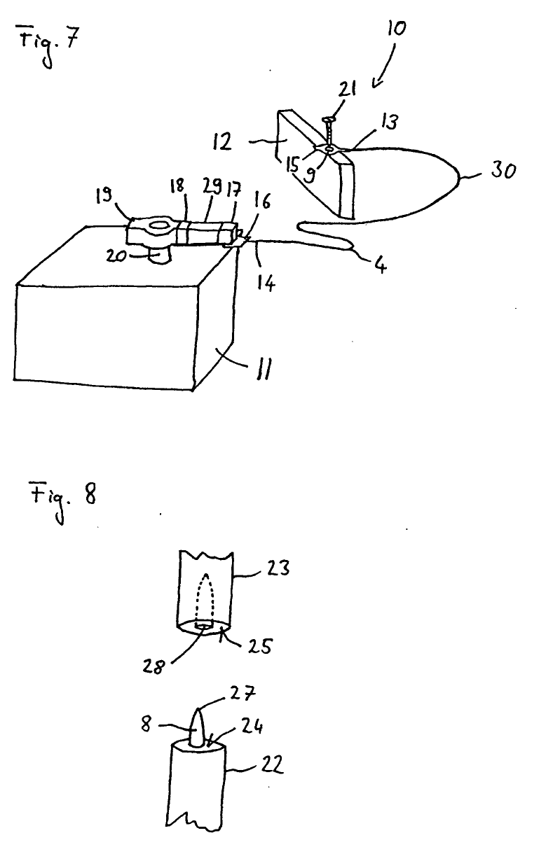

FIG. 7 shows schematically an arrangement with a cable according to an embodiment of the invention, and

FIG. 8 shows schematically a first and a second electrode of a device according to an embodiment of the invention.

In all the figures, the same parts are designated by the same references.

FIG. 1 shows schematically in plan view a forming tool 1 of a device according to an embodiment of the invention. The forming tool 1 has a cavity 2 for accommodating a stranded wire of a cable 30 with a broadened area 3 for accommodating a connection area of the cable 30. By way of example, the forming tool is made completely or predominantly from ceramic or other material, which is sufficiently temperature-resistant and has as low an electrical conductivity as possible.

For example, the forming tool 1 can be constructed so that, outside the broadened area 3, the cavity 2 is designed as a trough, which is open on one side, or as a closed channel, while in the broadened area 3 it is open in both directions perpendicular to the plane of the drawing so that two electrodes, which are not shown here, can be inserted from these directions.

FIG. 2 shows schematically the forming tool 1 with a cable 30 laid therein in a step of the method according to an embodiment of the invention. The cable 30 has a stranded wire 4 comprising a plurality of individual conductors 5, which are made of copper for example. A through opening is to be made in a connection area 6 of the cable 30. Outside the connection area 6, the cable 30 can have a cable sheath, which is not shown here, made from electrically insulating material.

FIG. 3 shows schematically a further step of the method according to an embodiment of the invention. In this step, a pin 8, which in this case of a single through opening divides the stranded wire 4 into two strands, is inserted in a through opening position 7. In doing so, the individual conductors 5 in the connection area 6 are pressed against the walls of the cavity 2 by the pin 8. A current, which heats the stranded wire 4 in the connection area 6 so that the individual conductors 5 deform and are fused to form a compact block, is applied to the stranded wire 4 in the connection area 6 by means of two electrodes, which are not shown here. The pin 8 is then removed from the through opening 9 shown. In the example shown, a single through opening 9 is made centrally in the connection area 6. However, it is also possible to create several through openings 9 at the same time and in any arrangement in the connection area 6 if an appropriate number of pins 8 are used and these are inserted in appropriate through opening positions 7.

FIG. 4 shows the cable 30 according to an embodiment of the invention. In the connection area 6, the stranded wire 4 with its individual conductors 5 is fused to form a compact block which has a central through opening 9. By choosing a suitable pin, the through opening 9 is dimensioned so that a screw or other fixing means can be fed through and the cable 30 can be fixed thereby in the connection area 6.

FIG. 5 shows the method step of inserting a pin 8 between the individual conductors 5 of the stranded wire 4 according to an alternative embodiment, the forming tool not being shown in this case. In this embodiment, the pin 8 does not divide the individual conductors 5 into several strands, but instead the individual conductors 5 are laid around the pin 8 in such a way that they form a partially or completely closed eye.

FIG. 6 shows the cable 30 according to the alternative embodiment of the invention. In the connection area 6, the stranded wire 4 with its individual conductors 5 is fused to form a compact block which has a central through opening 9.

FIG. 7 shows schematically an arrangement with a cable 30 according to an embodiment of the invention which has a car battery 11, one pole of which is to be connected to earth by making an electrical connection to a car body 12.

The cable 30 has a first end 13, which is intended to be connected to the car body 12, and a second end 14, which is intended to be connected to a pole of the car battery 11. At its second end, the cable 30 has a second connection area 16 in which the stranded wire 4 has been compacted to form a typically rectangular block. The second connection area 16 is connected by means of resistance brazing to a first connection piece 17 of a shunt 29. The shunt 29 is electrically connected via a pole terminal 19 to a pole head 20 of the car battery 11 by means of a second connection piece 18.

The first end 13 of the cable 30 has a first connection area 15 with a through opening 9 which has been produced as described with reference to FIGS. 1 to 4. A screw 21 is fed through the through opening 9 in order to releasably connect the first connection area 15 to the car body 12.

FIG. 8 shows schematically a first electrode 22 and a second electrode 23 of a device according to an embodiment of the invention. The first electrode 22 has a first contacting area 24 which is pressed against the individual conductors when the compacted connection area is produced. Furthermore, the first electrode 24 incorporates the pin 8 with the point 27, which makes it easier to insert the pin 8 between the individual conductors and to separate the stranded wire into two strands. The pin is made of ceramic or other material, for example, which is sufficiently temperature-resistant and has as low an electrical conductivity as possible.

The second electrode 23 has a second contacting area 25 with a recess 28 for the pin 8. In order to produce the compacted connection area, the first electrode 22 and the second electrode 23 are fed against the stranded wire from opposite sides, whereby the pin 8 divides the stranded wire into two strands. An electrical voltage is applied to the electrodes 22 and 23 so that a current flows through the stranded wire which is sufficient to heat said wire. The heated stranded wire deforms under the pressure of the contacting surfaces 24 and 25, and the individual conductors are fused to form a compacted block. In doing so, in conjunction with the recess 28, the pin 8 ensures that the electrodes 22 and 23 are correctly aligned with one another.

1-19. (canceled)

20. A cable, comprising:
a stranded wire including a plurality of individual conductors;
at least one connection area;
said stranded wire being fused to form a compacted block in said connection area having formed therein at least one through opening.

21. The cable according to claim 20, wherein said cable has a first end, and at least said first end incorporates said connection area.

22. The cable according to claim 20, wherein said through opening has a round configuration.

23. The cable according to claim 21, wherein said cable includes a second end and a first connection area at said first end, and a second connection area at said second end, said second end including a compacted block comprising a fused stranded wire, only said first end has said through opening, and said through opening is centrally located.

24. The cable according to claim 21, wherein said cable has a first connection area at said first end and a second connection area at a second end, said second end including a second compacted block comprising fused stranded wire, each of said compacted blocks has a through opening.

25. The cable according to claim 20, including an electrically insulating cable sheath that encloses said stranded wire.

26. The cable according to claim 20, wherein said connection area is connected to ground.

27. The cable according to claim 26, including a screw connecting said connection area to ground, and said screw is located in said through opening.

28. The cable according to claim 26, wherein said cable is a ground cable for a car battery in a car body, and said connection area is connected to the car body.

29. The cable according to claim 26, including a shunt connected to said one end.

30. A method for manufacturing a cable having at least one connection area, including the following steps:
providing a cable including a stranded wire comprising a plurality of individual conductors;
inserting at least one pin between the individual conductors of the stranded wire in the connection area; and
applying an electrical current to the stranded wire in the connection area and heating the stranded wire in the connection area for fusing the individual wires to form a compacted block with at least one through opening.

31. The method according to claim 30, including the step of using a forming tool with a cavity which has a broadened area to accommodate the connection area to fuse the individual wires to form a compacted block with at least one through opening.

32. The method according to claim 30, including the step of using a first electrode which has a pin and a second electrode which has a receptacle for receiving the pin to apply the electrical current.

33. The method according to claim 32, including the step of inserting the first electrode and the second electrode from opposite sides into the forming tool.

34. A device for compacting a connection area of a cable comprising stranded wire including a plurality of individual conductors, comprising:
a forming tool having a cavity for accommodating said stranded wire, said cavity including a broadened area for accommodating said connection area;
a first electrode including a first contact area and at least one pin being located between said individual conductors; and
a second electrode having a second contacting area and a receptacle for receiving said pin.

35. The device according to claim 34, wherein said forming tool has an electrical conductivity at least two orders of magnitude less than an electrical conductivity of said electrodes.

36. The device according to claim 34, wherein said pin has an electrical conductivity at least two orders of magnitude less than an electrical conductivity of said electrodes.

37. The device according to claim 34, wherein said forming tool is substantially ceramic.

38. The device according to claim 37, wherein said pin is substantially ceramic.
